(19) United States
(12) Patent Application Publication
(10) Pub. No.: US 2020/0223357 A1
(43) Pub. Date: Jul. 16, 2020

(54) VEHICLE SAFETY ALERT SYSTEM

(71) Applicant: Joseph G. DePrisco, Fort Wayne, IN (US)

(72) Inventor: Joseph G. DePrisco, Fort Wayne, IN (US)

(21) Appl. No.: 16/739,878

(22) Filed: Jan. 10, 2020

Related U.S. Application Data
(60) Provisional application No. 62/791,475, filed on Jan. 11, 2019.

(51) Int. Cl. B60Q 5/00; B60Q 9/00; B60W 50/14; G08G 1/04; G08G 1/16

(52) U.S. Cl. CPC B60Q 5/006; B60Q 9/008; B60W 2050/143; G08G 1/04; G08G 1/166; B60W 50/14

(57) ABSTRACT

A safety alert system for a vehicle including, a controller at least one detector and at least one alarm. The controller is connected to the vehicle. The detector is mounted to the vehicle, and is in communication with the controller. The alarm is communicatively coupled to the controller. The detector senses an approaching vehicle velocity and distance of the approaching vehicle. The detector sends a signal to the controller representative of the velocity and distance of the approaching vehicle. The controller uses the signal to determine if the approaching vehicle is decelerating within a predetermined level, and the controller activates the alarm if the deceleration is not within the predetermined level.

### CROSS REFERENCE TO RELATED APPLICATIONS

This is a non-provisional application based upon U.S. provisional patent application Ser. No. 62/791,475, entitled “VEHICLE SAFETY ALERT SYSTEM”, filed Jan. 11, 2019, which is incorporated herein by reference.

### BACKGROUND OF THE INVENTION

### 1. Field of the Invention

The present invention relates to a vehicle safety system that alerts a driver or others in the vicinity, if a vehicle is approaching the driver's vehicle, such as a school bus, at an unsafe velocity.

### 2. Description of the Related Art

Tragic news stories involving children being hit by an automobile when walking to or away from a school bus, or while riding on a bus. In the majority of states a school bus driver is only empowered to activate warning lights and extend a stop sign to hopefully control the flow of traffic in the vicinity of the school bus. Many tragic accidents could be avoided if only the drivers of approaching vehicles had more advance warning in real time, i.e. at the exact moment they were driving in an area in which a potential hazard is present. For example, an accident between a car and, a bus could be avoided if the car driver had better real time warnings when the car is in close proximity to the bus, at an unsafe speed pattern. Further, a child struck by an automobile after exiting a school bus could have been saved if drivers approaching the loaded bus would have been clearly alerted about a stopping or completely stopped school bus.

What is needed in the art is an interactive warning system that can detect a potential danger and issue an alert

### SUMMARY OF THE INVENTION

The present invention provides an alert system for a vehicle.

The invention in one form is directed to a safety alert system for a vehicle including, a controller at least one detector and at least one alarm. The controller is connected to the vehicle. The detector is mounted to the vehicle and is in communication with the controller. The alarm is communicatively coupled to the controller. The detector senses an approaching vehicle velocity and distance of the approaching vehicle. The detector sends a signal to the controller representative of the velocity and distance of the approaching vehicle. The controller uses the signal to determine if the approaching vehicle is decelerating within a predetermined level, and the controller activates the alarm if the deceleration is not within the predetermined level.

The invention in another form is directed to a safety alert system for a vehicle, the safety alert system including, a controller at least one detector and at least one alarm. The controller and the detector are mounted to the vehicle, and the at least one detector is in communication with the controller. Also, the at least one alarm is communicatively coupled to the controller. The controller executes the steps of: detecting a distance to an approaching vehicle; determining a velocity of the approaching vehicle; calculating a deceleration value of the approaching vehicle; and activating the at least one alarm if the deceleration value is not within a predetermined level.

The invention in yet another form is directed to a safety alert method for a vehicle, the safety alert method including the steps of detecting a distance to an approaching vehicle; determining a velocity of the approaching vehicle; calculating a deceleration value of the approaching vehicle; and activating the at least one alarm if the deceleration value is not within a predetermined level.

An advantage of the present invention is that the system elevates the alert system when an approaching vehicle is not slowing at an appropriate rate.

Another advantage is the alerts of the system are directed to the oncoming vehicle and to passengers or those proximate to a stopped passenger vehicle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic side view of an embodiment of a vehicle safety alert system displayed in a bus relative to two other vehicles;

FIG. 2 is a flowchart that describes how an embodiment of the vehicle safety alert system used in the bus of FIG. 1; and

FIG. 3 is a schematic block diagram that executes the method illustrated in the flowchart of FIG. 2.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

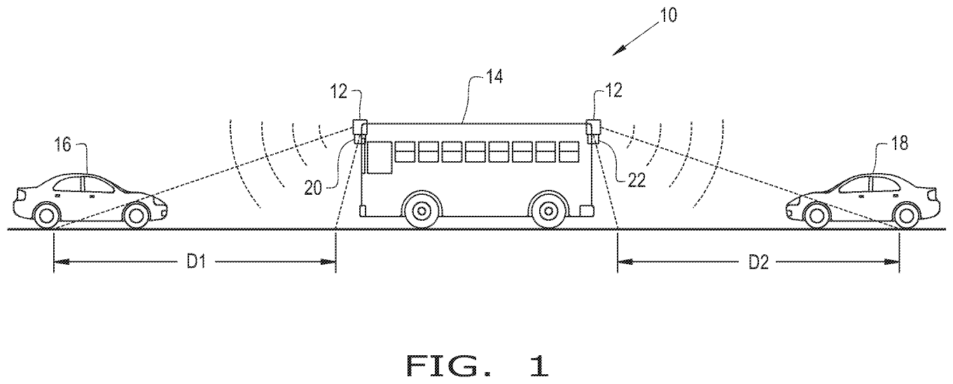

Referring now to the drawings, and more particularly to FIG. 1, there is shown a vehicle alert system 10 in the form of long range sensing devices 12 mounted in a way to sense oncoming traffic ahead and behind of a stopped public transportation vehicle (PTV) 14, most importantly a school bus 14.

In one embodiment system 10 receives a signal from the existing PTV 14 electrical system that vehicle 14 was stopped, which typically could include the activation of a swing out stop sign, a boarding arm, etc. indicative of passengers being about to board or leave vehicle 14. With this activation signal, sensing detectors 12, such as radar, laser, ultrasonic, optical or a combination thereof, evaluates approaching vehicles 16 and 18 relative to PTV 14, calculating the rate of approach, in the form of speed and distance and with that information sets off a series of alerting options if predetermined thresholds are violated.

Once device 10 confirms the presence of an approaching vehicle 16 or 18 at some reasonable set braking distance D1 or D2, such as 500 feet, the rate speed/distance/deceleration is calculated within an internal algorithm and based on that information additional safety measures may be activated:
If vehicle 16 or 18 is well within an acceptable deceleration pattern no alarms would activate and the existing PTV 14 safety gear in place would continue to be sufficient.
If approaching vehicle 16 or 18, fore or aft of PTV 14, is within a “slow” approach pattern but not significantly decelerating within a calculated range, a series of lights 20 or 22 would be activated on the PTV 14 indicating an immediate stop is required. This could be a significant light system on the PTV 14 or another device to alert the driver.
If approaching vehicle 16 or 18 is determined to be operating at a higher speed, not in an acceptable decelerating pattern, additional alarms would activate external and internal to PTV 14. In the most common case, this signal of an approaching, non-decelerating vehicle 14 would set off a series of ever increasing audible alarms onboard PTV 14 to alert entering or exiting passengers to pay attention to oncoming vehicles and to remain in place or distance themselves from the roadway or path of traffic.

These alarms could incorporate the existing horn of PTV 14 in various patterns, such as pulses or solid blasts indicating conditions, or possibly high intensity sirens internal to the sensing device 12 could be utilized. It is also contemplated to actively direct acoustical and/or light alerts toward vehicle 16 or 18.

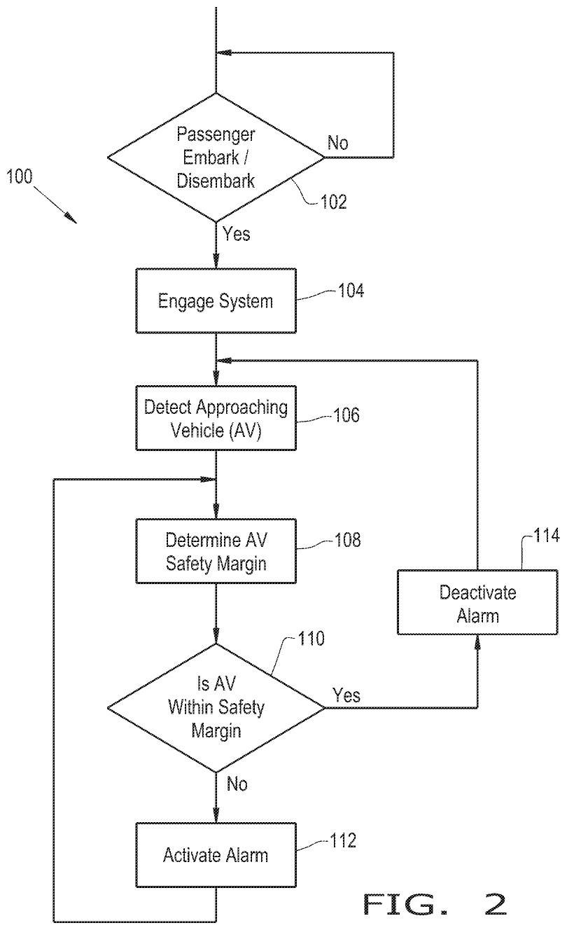

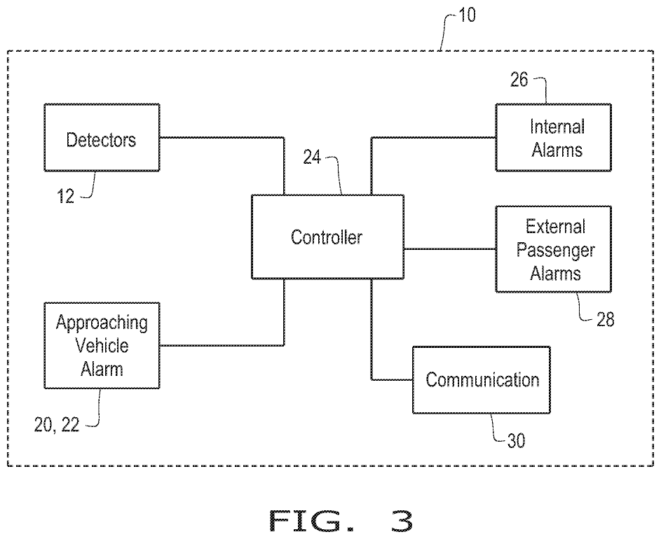

Now, additionally referring to FIGS. 2 and 3, there is shown a method 100 that is executed by a controller 24. Controller 24 is communicatively coupled to detectors 12, approaching vehicle alarms 20 and 22, internal alarms 26, external passenger alarms 28 and communication device 30.

Method 100 is carried out by controller 24 and the elements connected thereto. Controller 24 may be an electronic controller that executes method 100 in the form of an algorithm. At step 102, bus 14 is stopped, or nearly stopped, typically with flashing lights being activated and at least one stop sign being extended from the side of bus 14. If a stop mode of bus 14 is detected at step 102, then system 10 is engaged at step 104. Approaching vehicle 16 or 18 is detected at step 106 by detectors 12 with the distance D1 or D2 as well as the velocity of vehicle 16 or 18 being sent to controller 24. Controller 24 calculates the change in velocity of vehicles 16 and 18, which results in a deceleration rate of vehicles 16 and 18.

At step 108, controller 24 determines if approaching vehicle 16 and/or 18 has a deceleration rate that is at a safe predetermined level, which indicates that vehicle 16, 18 is not a threat to bus 14. The safety margin can be a multiple level margin, in that a first level of alert can be activated if a first predetermined deceleration rate is violated and a second level of alert can be activated if a second predetermined deceleration rate is violated. At step 110 the determination of whether a particular predetermined deceleration rate is violated takes place. If a violation is determined at step 110, then method 100 proceeds to step 112. If no violation is detected at step 110, then method 100 proceeds to step 114, where alarms 20, 22, 26 and 28 are deactivated.

At step 112, an alarm 20, 22, 26 and/or 28 is activated depending upon the level of violation and the particular direction in which the violation is occurring. For example, if car 16 is approaching stopped bus 14 and detector 12 indicates that car 16 is distance D1 and the deceleration rate of car 16 violates the first predetermined value of deceleration that alarm 20 is activated to alert the driver of car 16 that attention to slowing car 16 is needed. If the deceleration rate of car 16 is violating the second predetermined value of deceleration, indicating that car 16 is not likely to stop before reaching bus 14, then controller 24 will activate internal alarms 26 and/or external alarms 28 to alert those on or near bus 14 of impending potential danger.

Alarm 20 may be strobe lights, additional flashing lights, sound and/or directed lights/sound. Similarly alarms 22, 26 and 28 may be a combination of visual and sound alerts. It is also contemplated that a verbalized command may be issued by the alarms.

Safety alert system 10 for vehicle 14 includes a controller 24, at least one detector 12 and at least one alarm 20, 22, 26, 28. Controller 24 is connected to vehicle 14, and to detectors 12, which are mounted to fore and aft portions of vehicle 14, detectors 12 and controller 24 are in communication with each other. Alarms 20, 22, 26, 28 are also communicatively coupled to controller 24. Detector 12 senses an approaching vehicle 16, 18 velocity and distance D1, D2 of approaching vehicle 16, 18. Detector 12 sends a signal to controller 24 representative of the velocity and distance of approaching vehicle 16, 18. Controller 24 uses the information of the signal to determine if approaching vehicle 16, 18 is decelerating within a predetermined level, and controller 24 activates at least one of the alarms 20, 22, 26, 28 if the deceleration is not within the predetermined level.

Alarm 20, 22 is at least one of a visual alarm and an acoustic alarm oriented toward the approaching vehicle. Alarm 20, 22 can be actively directed toward the approaching vehicle by way of an orienting mechanism (not shown). Alarms 20, 22, 26, 28 include a first alarm 20, 22 and a second alarm 26, 28, the first alarm 20, 22 being generally directed toward the approaching vehicle 16, 18, and the second alarm 26, 28 is generally directed to people in or proximate to vehicle 14 having safety alert system 10. Controller 24 is communicatively coupled to both the first alarm 20, 22 and the second alarm 26, 28.

Controller 24 determines if the deceleration of approaching vehicle 16, 18 is within an other predetermined level, and if the deceleration of approaching vehicle 16, 18 is not within the predetermined level, but is within the other predetermined level then controller 24 activates the first alarm 20, 22. If the deceleration of approaching vehicle 16, 18 is not within the predetermined level and is not within the other predetermined level then controller 24 activates first alarm 20, 22 and second alarm 26, 28.

Controller 24 does not activate an alarm 20, 22, 26, 28 unless vehicle 14 has stopped or has activated a stopping alert, such as flashing lights or an extended stop sign.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A safety alert system for a vehicle, the safety alert system comprising:
a controller connected to the vehicle;
at least one detector mounted to the vehicle, the at least one detector being in communication with the controller; and
at least one alarm communicatively coupled to the controller, the detector sensing an approaching vehicle velocity and distance of the approaching vehicle, the detector sending a signal to the controller representative of the velocity and distance of the approaching vehicle, the controller using the signal to determine if the approaching vehicle is decelerating within a predetermined level, the controller activating the at least one alarm if the deceleration is not within the predetermined level.

2. The safety alert system of claim 1, wherein the at least one alarm is at least one of a visual alarm and an acoustic alarm oriented toward the approaching vehicle.

3. The safety alert system of claim 2, wherein the at least one alarm is actively directed toward the approaching vehicle.

4. The safety alert system of claim 1, wherein the at least one alarm includes a plurality of alarms including a first alarm and a second alarm, the first alarm being generally directed toward the approaching vehicle, the second alarm being generally directed to people in or proximate to the vehicle having the safety alert system, the controller being communicatively coupled to both the first alarm and the second alarm.

5. The safety alert system of claim 4, wherein the controller determines if the deceleration of the approaching vehicle is within an other predetermined level.

6. The safety alert system of claim 5, wherein if the deceleration of the approaching vehicle is not within the predetermined level, but is within the other predetermined level then the controller activates the first alarm.

7. The safety alert system of claim 5, wherein if the deceleration of the approaching vehicle is not within the predetermined level and is not within the other predetermined level then the controller activates the first alarm and the second alarm.

8. The safety alert system of claim 1, wherein the controller does not activate the at least one alarm if the vehicle with the safety alert system is not stopped.

9. A safety alert system for a vehicle, the safety alert system comprising:
a controller connected to the vehicle;
at least one detector mounted to the vehicle, the at least one detector being in communication with the controller; and
at least one alarm communicatively coupled to the controller, the controller executing the steps of:
detecting a distance to an approaching vehicle;
determining a velocity of the approaching vehicle;
calculating a deceleration value of the approaching vehicle; and
activating the at least one alarm if the deceleration value is not within a predetermined level.

10. The safety alert system of claim 9, wherein the at least one alarm is at least one of a visual alarm and an acoustic alarm oriented toward the approaching vehicle.

11. The safety alert system of claim 10, wherein the at least one alarm is actively directed toward the approaching vehicle by the controller.

12. The safety alert system of claim 8, wherein the at least one alarm includes a plurality of alarms including a first alarm and a second alarm, the first alarm being generally directed toward the approaching vehicle, the second alarm being generally directed to people in or proximate to the vehicle having the safety alert system, the controller being communicatively coupled to both the first alarm and the second alarm.

13. The safety alert system of claim 12, wherein the controller determines if the deceleration value is within an other predetermined level.

14. The safety alert system of claim 13, wherein if the deceleration value is not within the predetermined level, but is within the other predetermined level then the controller activates the first alarm.

15. The safety alert system of claim 13, wherein if the deceleration value is not within the predetermined level and is not within the other predetermined level then the controller activates the first alarm and the second alarm.

15. A method of activating a safety alert system of a vehicle, the method including the steps of:
detecting a distance to an approaching vehicle;
determining a velocity of the approaching vehicle;
calculating a deceleration value of the approaching vehicle; and
activating an alarm if the deceleration value is not within a predetermined level.

16. The method of claim 15, wherein the at least one alarm is at least one of a visual alarm and an acoustic alarm oriented toward the approaching vehicle.

17. The method of claim 15, wherein the at least one alarm includes a plurality of alarms including a first alarm and a second alarm, the first alarm being generally directed toward the approaching vehicle, the second alarm being generally directed to people in or proximate to the vehicle having the safety alert system.

18. The method of claim 17, further comprising the step of determining if the deceleration value is within an other predetermined level.

19. The method of claim 18, further comprising the step of determining if the deceleration value is not within the predetermined level, but is within the other predetermined level then activating the first alarm.

20. The method of claim 18, further comprising the step of activating the first alarm and the second alarm if the deceleration value is not within the predetermined level and is not within the other predetermined level.
